(19) United States
(12) Patent Application Publication
(10) Pub. No.: US 2008/0192905 A1
(43) Pub. Date: Aug. 14, 2008

(54) STORAGE AND RETRIEVAL OF A CALLER'S SPOKEN NAME

(75) Inventor: TIMOTHY J. FUJITA-YUHAS, SEATTLE, WA (US)

Correspondence Address: Stolowitz Ford Cowger LLP, 621 SW Morrison St, Suite 600, Portland, OR, 97205, US

(73) Assignee: CISCO TECHNOLOGY, INC., SAN JOSE, CA (US)

(21) Appl. No.: 11/674,595

(22) Filed: Feb. 13, 2007

(51) Int. Cl. H04M 1/64

(52) U.S. Cl. 379/88.21

(57) ABSTRACT

A system including a data storage device for storing an audio recording of a customer or caller's name recorded in the customer's own voice, and a voice processing application for providing audio communication between the customer and a user of the system. The stored customer name is retrieved from the data storage device according to an associated customer identification and played out to the user of the system as part of the communication session.

### TECHNICAL FIELD

The invention relates to managing communications and providing an improved system of caller identification.

### BACKGROUND

In the quest to provide more personalized experiences for customers of companies who are in service, sales or support industries, the ability to correctly pronounce a customer's name can be a key advantage to making the customer feel valued. It is not always apparent how to pronounce a customer's name when viewed in writing. This can be due to differences in regional pronunciations or unfamiliarity with names that are increasingly international in usage.

A customer that calls a company is often confronted with an automated teller who requests information such as an account number or the nature of the call. This information may be useful to determine the nature of the call and to whom the caller should be directed. In some cases, the automated teller may request the caller to state their name. When an employee of the company is located, the automated attendant may then play out the caller's name prior to connecting the caller so that the employee may greet the customer using the correct pronunciation.

Each time the customer calls the company, they are required to enter or state the same or similar information to the automated teller. The customer may be directed to different employees in the company who may also be unfamiliar with how to correctly pronounce the customer's name. Requiring the customer to repeat their name each time they call runs counter to the overall purpose of making the customer feel valued.

The present invention addresses these and other problems associated with the prior art.

### BRIEF DESCRIPTION OF THE DRAWINGS

FIG. 1 illustrates an example block diagram of a simplified voice system including a voice processing application.

FIG. 2 illustrates an example block diagram of a voice system including a voice processing application and a data storage device.

FIG. 3 illustrates an example block diagram of a customer entry including a customer identification and voice information.

FIG. 4 illustrates an example block diagram of a voice system connected to a contact manager.

FIG. 5 illustrates an example block diagram of a voice system including an automated attendant.

FIG. 6 illustrates an example block diagram of a voice system including one or more callers.

FIG. 7 illustrates an example operation of storing and retrieving voice information in a voice system.

FIG. 8 illustrates an example operation of retrieving and processing voice information in a voice system.

FIG. 9 illustrates an example block diagram of a voice system connected to an external recording device.

### DESCRIPTION OF EXAMPLE EMBODIMENTS

Overview

An apparatus is herein disclosed as including a voice processing application of a voice system configured to record a voice signature, associate the voice signature with a customer identity, store the voice signature, and retrieve the voice signature using the customer identity. The voice signature is recorded using the customer's own voice.

A system including a data storage device for storing an audio recording of a customer name recorded in the customer's own voice, and a voice processing application for providing audio communication between the customer and a user of the system. The stored customer name is retrieved from the data storage device according to an associated customer identification and played out to the user of the system as part of the communication session.

A method is herein disclosed as comprising capturing voice information including a customer's name spoken in the customer's own voice, associating the voice information with a customer identification and storing the voice information. The method further comprises receiving a call indicating the customer identification, and retrieving the voice information associated with the customer identification.

The invention will become more readily apparent from the following detailed description of a preferred embodiment of the invention which proceeds with reference to the accompanying drawings.

### DETAILED DESCRIPTION

Retention and retrieval of customer information can be the difference between keeping a customer and losing them to a competitor. A customer wants to feel important and may have a more positive view of a company who provides the customer with a more personal experience. Maintaining customer loyalty can lead to repeat business and favorable word of mouth advertising. In addition to retaining important customer information as it relates to business transactions and contact information such as addresses and telephone numbers, many successful business people like to retain personal information on customers such as names of family members. This provides a personal touch to communications with the customer. Even more basic to a successful and amicable communication is the ability to correctly pronounce the customer's name. Nothing starts of a conversation worse than getting the customer's name wrong or mispronouncing it.

Unfortunately, conventional voice systems and contact managers are not designed to retain and retrieve voice information provided by the customer. Instead, businesses are forced to rely on individual employees to decipher a written name or remember the customer's name perhaps from a previous phone call. Some devices, including mobile phones, allow the phone's owner to store names associated with phone numbers. However, the person's name is still subject to mispronunciation by the owner of the phone. Worse yet, some systems provide a computerized rendition of the customer's name based on the spelling and certain logical conventions or text to speech applications which can result in even more confusion and error.

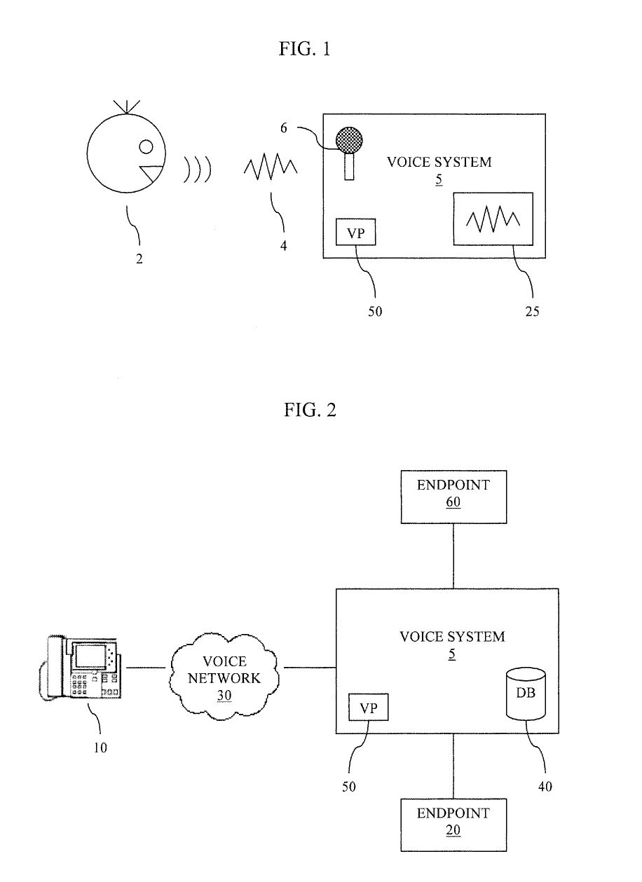

FIG. 1 illustrates an example block diagram of a simplified voice system 5 including a voice processing application 50. The voice system 5 may be any device that processes voice information such as calls. The voice system 5 may provide services including voice mail, interactive voice response (IVR), call waiting or other custom voice applications. The customer voice application may include services such as providing a phone tree, database access or customer registration. The voice system 5 is shown as including a recording device 6 which may be any device capable of recording a spoken voice. The recording device 6 may be internal to the voice system 5 or otherwise connected.

The voice system 5 may be integrated with a company who is in the service, sales or support industries. However, it should be understood that the system may be used in nearly any type of company or industry and benefit from the features and advantages described herein. A customer 2 of the company may contact the company through the voice system 5. The customer 2 speaks their name 4 to the voice system 5. The recording device 6 records the name 4 using the customer's own voice, such that an audio recording of the spoken name 4 is stored as a voice signature or as voice information 25.

The voice processing application 50 may control and process the voice information 25 as part of a call session, for example. The voice processing application 50 may control or assist the recording device 6 in the recording of the voice information 25. The voice processing application may further associate the voice information 25 with the customer 2 according to some type of customer identity such as a phone number, service contract, or account number. The recorded voice information 25 may then be stored, and later retrieved. For example, the voice processing application 50 may be configured to retrieve the voice information 25 using an identity of the customer 2.

FIG. 2 illustrates an example block diagram of a voice system 5 including a voice processing application 50 and a data storage device 40. A caller 10 is shown connected to the voice system 5 through a voice network 30. The caller 10 may be a customer, such as customer 2 of FIG. 1, calling the voice system 5 using an analog phone, digital phone, mobile phone, soft phone, personal digital assistant or any other device that is capable of transmitting voice information. Voice network 30 may be a plain old telephone system (POTS), a digital or cable network, a cellular network, a satellite network, the Internet, or any other network capable of exchanging voice information. Voice network 30 may transmit calls and voice information by methods such as time-division multiplexing (TDM) or voice over internet protocol (VoIP).

The voice system 5 is shown as including two users or endpoints 20 and 60, who may be system users or employees of a company that the caller 10 is calling. Of course there may be many more system users than the endpoints 20, 60 shown in FIG. 2. Endpoints 20, 60 may be provided with an analog phone, digital phone, mobile phone, soft phone, personal digital assistant or any other device that is capable of transmitting or receiving voice information. Endpoints 20, 60 may be connected to the voice system 5 as part of an intranet, virtual network, local area network, wide area network, or any other system known in the art for exchanging voice information.

The data storage device 40 may be used for storing an audio recording of a customer name, for example voice information 25 of FIG. 1, recorded in the customer's own voice. Voice processing application 50 is configured to provide audio communication between the caller 10, or customer, and one or more of the endpoints 20, 60 or users of the system during a communication session. The stored voice information 25, or customer name, may be retrieved from the data storage device 40 and played out to one or more of the endpoints 20, 60 as part of the communication session. In this manner, the voice information 25 is made retrievable at multiple different times and by multiple different users of the system.

In one embodiment, voice information 25, which may include the stored customer name, is played out during a call screening process prior to transferring a call from caller 10 to a user, such as endpoints 20. Endpoint 20 may then determine whether or not they would like to accept the call from the caller 10, forward the caller 10 to another user, such as endpoint 60, or transfer the caller 10 to voice mail. In one embodiment, the caller 10 may determine whether they want to be transferred to endpoint 60 or to voice mail.

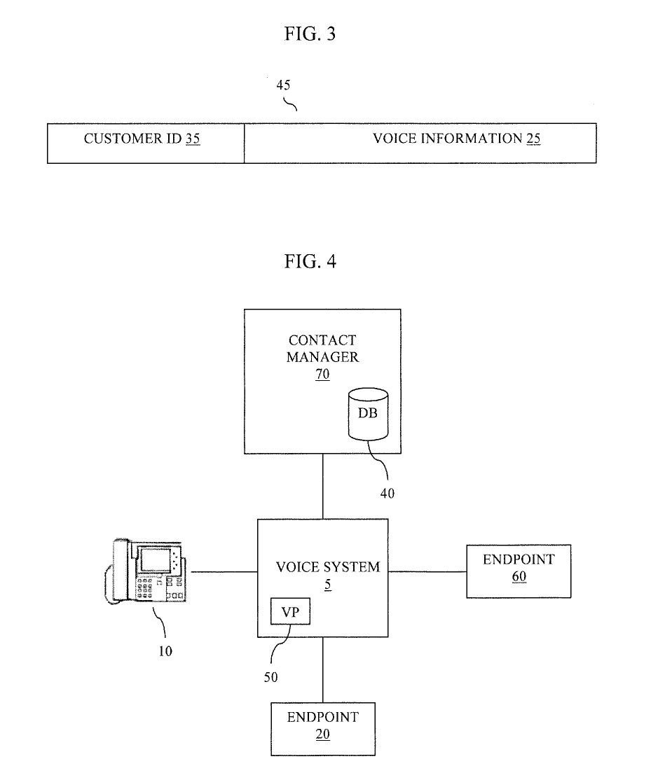

FIG. 3 illustrates an example block diagram of a customer entry 45 including a customer identification 35 and voice information 25. The customer identification 35 may include a phone number, service contract, or account number. When caller 10 of FIG. 2 is connected to the voice system 5, the phone number of the caller 10 may be captured as part of a caller identification system, such as direct inward dial (DID) used in the North America Dial Plan (NADP). Caller Identification based on NADP is recognizable as phone numbers that have 10 digits, including area code and a local calling number. Most phones, including mobile phones, have a unique phone number. A caller 10 may additionally or alternatively be prompted to enter a user account number or a service contract, which may be of a varying number of digits and/or characters. The caller 10 may be identified by the customer identification 35.

The voice information 25, which may include an audio recording of the caller's name spoken by the caller 10, may be associated with the customer identification 35 as the customer entry 45. Customer entry 45 may be stored in a database, such as the data storage device 40 of FIG. 2. The stored customer name which may be provided with the voice information 25 may be retrieved from the data storage device 40 according to the associated customer identification 35.

In one embodiment, the voice information 25, which may include a voice signature such as the caller's name, is recorded during a first voice call session. For example, the caller 10 of FIG. 2 calls endpoint 20 and is prompted to speak their name during a call session or screening operation. The voice system 5 may store the voice information 25 in the data storage device 40 as part of the customer entry 45. When the caller 10 calls a second time, to either endpoint 20 or 60, the voice information 25 may be retrieved by the voice processing application 50 during a second voice call session. In this way, either endpoint 20 or 60 may play out the caller's voice included in the voice information 25 without requiring the caller 10 to restate their name. The customer's name is therefore retained for subsequent use in the voice system 5.

In one embodiment, the voice information 25 is retrieved prior to or during a call processing of the second voice call session, where the voice processing application 50 of FIG. 2 is configured to cause the voice information 25 to be played out to one or more users, such as endpoints 20, 60. The voice processing application 50 is able retrieve the voice information 25 for multiple call sessions occurring at different times. In one embodiment an endpoint, such as endpoint 20, may retrieve the voice information 25 prior to or as part of returning a phone call made by either caller 10 or endpoint 60. For example, caller 10 or endpoint 60 may have earlier called endpoint 20 and left a voice mail.

FIG. 4 illustrates an example block diagram of a voice system 5 connected to a contact manager 70. Contact manager 70 may include customer contact information such as names, addresses, phone numbers, e-mails, fax numbers, and other customer information. The contact manager 70 is shown as including a data storage device 40. The data storage device 40 may store the customer contact information, for example of caller 10. In one embodiment, the data storage device 40 associated with contact manager 70 is configured to store voice information 25. The voice information 25 may be associated with any of the customer contact information, such as customer identification 35 of FIG. 3. Data storage device 40 may therefore be accessible for storage and retrieval of customer information including voice information 25 and customer's names, by either or both of the voice system 5 and the contact manager 70.

Voice information 25 may be similarly stored in and retrieved from the data storage device 40 of FIG. 4 and FIG. 2, even though the data storage device 40 is shown located in alternative locations or systems. In one embodiment, the data storage device 40 is accessed to retrieve the voice information 25 independently from any call being received from the caller 10. For example, a system user such as endpoint 20, 60 may want to retrieve the voice information 25 in order to listen to the customer's name prior to initiating a call or meeting with the customer. An audio recording of the customer's name may therefore be conveniently located, stored and be made retrievable along with other customer contact information, in a common or commonly accessible database or databases such as data storage device 40.

In one embodiment, the contact manager 70 includes a separate voice mail system that services its own endpoints (not shown). Voice information 25 and other customer contact information could be shared between the voice system 5 and the contact manager 70, providing access to customer information for more than one voice system. Customer information could be copied or replicated from one system to another, wherein each of the voice systems may include their own database, such as data storage device 40.

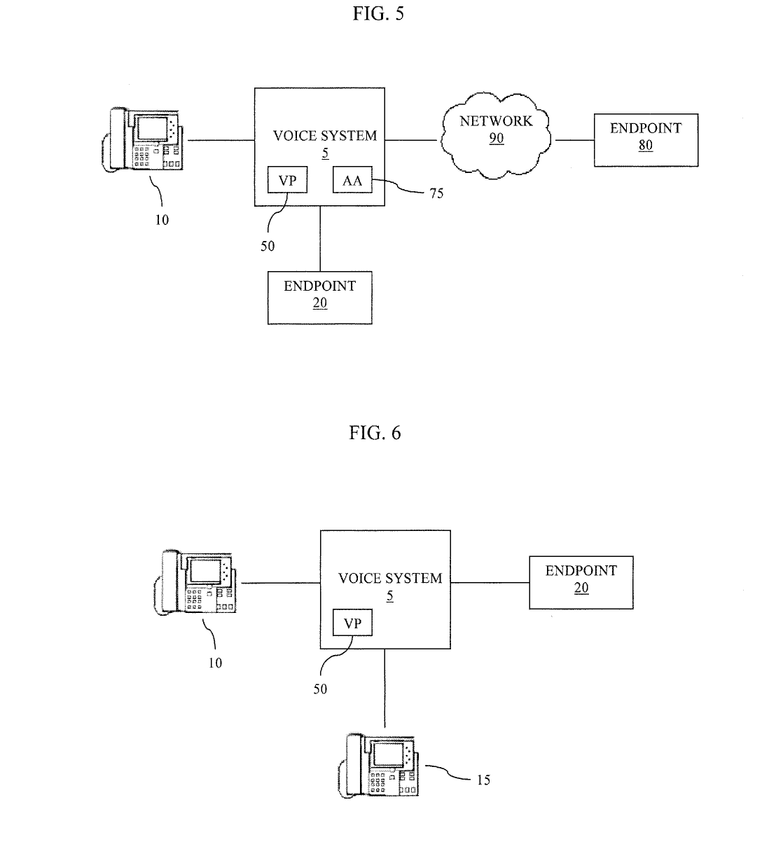

FIG. 5 illustrates an example block diagram of a voice system 5 including an automated attendant 75. Automated attendant 75 may be provided in the voice system 5 as part of an IVR, voice mail, or custom voice application. The automated attendant 75 may be used to prompt caller 10 to enter account information, select from a menu, or speak their name. The caller 10 may enter the information by any combination of voice utterance or button selection, for example by a pressing number pad on a telephone. Voice system 5 may include a voice or speech recognition application that recognizes and converts the voice utterance to digital information, for example. The voice processing application 50 may be used to control, coordinate or assist the automated attendant 75 with call session and voice data management. The automated attendant 75 may be provided as a feature or operation of the voice processing application 50.

The automated attendant 75 may provide a menu option that allows the caller 10 to select a system endpoint that they want to be connected to. For example, the caller 10 may speak or enter an extension of endpoint 20 or spell or say the name of the person associated with endpoint 20. In one embodiment, the automated attendant plays out the endpoint's name in the endpoint's own voice to the caller 10. For example, after caller 10 selects an identification, such as an extension, for endpoint 20, the endpoint's name is played out.

Endpoint 80 is shown connected to the voice system 5 via a network 90. Endpoint 80 may be a customer, partner or Internet subscriber of a company that has implemented the voice system 5. Endpoint 80 may not have or share a voice mail account in the voice system 5. In one embodiment, caller 10 uses the voice system 5 by selecting an identification of either endpoint 20 or 80 through the automated attendant 75. It may appear to the caller 10 that both endpoints 20 and 80 are integrated in the system whereas endpoint 80 may in fact not be an employee of the company. A call made by caller 10 may be transferred to the endpoint 80, residing outside of the voice system 5. In one embodiment, endpoint 80 provides a contractual service for the company, such as customer support, product warranty, parts replacement, or repair services. Voice processing application 50 may be configured to allow endpoints 20, 80 to retrieve one another's voice information 25, including recorded names, as well as the voice information 25 of caller 10, for example.

FIG. 6 illustrates an example block diagram of a voice system 5 including one or more callers 10 and 15. The recording, storage and retrieval of voice information 25 associated with callers 10, 15 may be as previously described, wherein the voice processing application 50 may be configured to play out the recorded name of one or more of the customers to endpoint 20. In one embodiment, the caller 10 may be prompted or allowed to revise their associated voice information 25 or other customer information. For example, the voice processing application 50 may be configured to change the stored voice signature included in the voice information 25 at the request of the caller 10 or customer. The voice processing application 50 may also be configured to change a phone number associated with the customer identification 35 of FIG. 3. In one embodiment, a caller calling from phone 10 is able to select or enter an alternate or additional phone number associated with a different to phone, such as phone 15, that is not being used to make the present call.

Caller identification may be incomplete or of questionable accuracy. For example, caller identification may be blocked by the caller 10. Some calls may be routed through one or more countries, making it difficult to identify the caller 10 according to caller identification. Still other calls may be received over multiple lines bundled together from a single carrier, or trunk. Providing the caller 10 with the ability to revise or provide the voice information 25 or customer identification 35 when the caller identification is incomplete or questionable provides a means for further managing the customer data.

FIG. 7 illustrates an example operation of storing and retrieving voice information in a voice system 5. At operation 710 voice information, such as voice information 25 of FIG. 1, is captured including a customer's name spoken in the customer's own voice. The voice information 25 may be captured by a voice recorder such as recording device 6 of FIG. 1.

At operation 720 the voice information 25 is associated with a customer identification, such as customer identification 35 of FIG. 3. The customer identification 35 may include an account number, service contract or phone number of the customer as provided by the customer or as captured as part of a caller identification application. For example, the caller identification application may identify a ten-digit DID phone number that is part of the North America Dial Plan. Phone numbers in Europe, Asia or other parts of the world may be captured as part of other phone system dialing plan conventions possibly including different numbers of digits. The number of digits included in the phone number may be used to help identify the caller.

At operation 730, the voice information 25 is stored. The voice information 25 may be stored in a database such as data storage device 40 in FIGS. 2 and 4. The voice information 25 may be stored as data entry such as customer entry 45 of FIG. 3. Voice information may be stored or associated with a customer phone number or other customer information.

At operation 740, a call indicating the customer identification 35 is received. The customer identification 35 may be entered by the caller, such as caller 10 of FIGS. 2 and 4-6, or may be captured as part of a caller identification feature.

At operation 750, the voice information 25 associated with the customer identification 35 is retrieved. In one embodiment, the caller 10 is not required to state their name during the call, having previously supplied this information. Rather a pre-existing audio recording of the caller's name, spoken in the caller's own voice, is retrieved. The customer's name may therefore be stored and retrieved by multiple different users and at multiple different times. The customer identification 35 may identify the customer being called or who is calling.

In one embodiment, stored voice data such as voice information 25 associated with the customer identification 35 may be replaced or revised at a request of the caller 10 or customer. The customer may include users of the voice system 5, such as endpoint 20 or endpoint 80 of FIG. 5, who may similarly be able to replace or revise their own personal information.

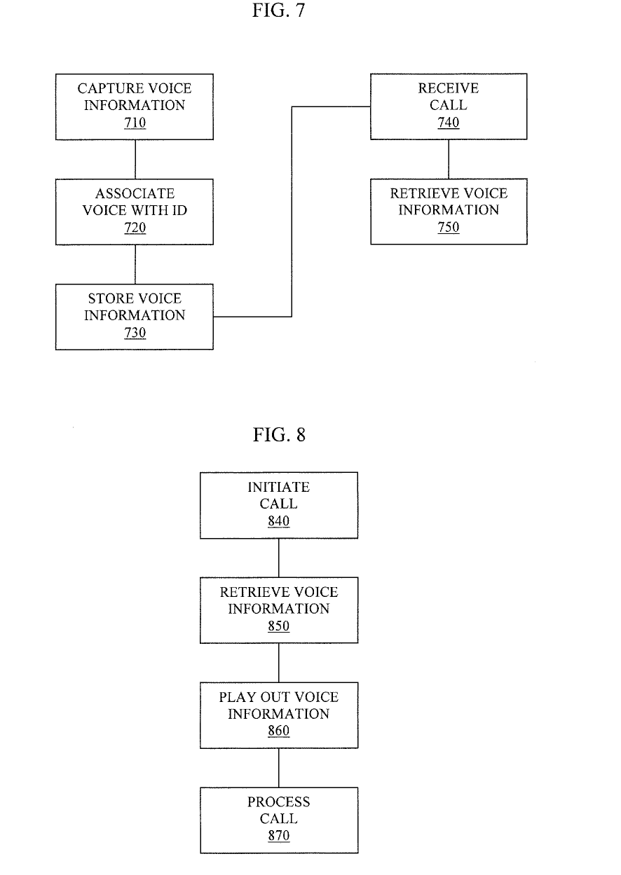

FIG. 8 illustrates an example operation of retrieving and processing voice information in a voice system 5. At operation 840, a call indicating the customer identification 35 is initiated. The call might be initiated by an outside caller, by a customer, or by a system user.

At operation 850, the voice information 25 associated with the customer identification 35 is retrieved. Operation 850 may be performed similarly to operation 750 as previously described.

At operation 860, the stored voice information 25 is played out. The voice information 25 may be played out prior to or during a call processing session. The customer identification 35 may identify the caller who is initiating the call session, or may identify the customer to whom the call is being made.

At operation 870, the call by or to the customer is resumed or processed during a call processing session. In one embodiment, the customer 10 may be transferred to voice mail, or the customer 10 may be transferred to a system endpoint, such as endpoints 20, 60, 80 of FIGS. 2, 4-6. In another embodiment, a system user 20 may be connected to the customer 10 or another system user, such as endpoint 60 of FIG. 2. In yet another embodiment, the endpoint 20 may be connected to the customer 10 or endpoint 80 of FIG. 5.

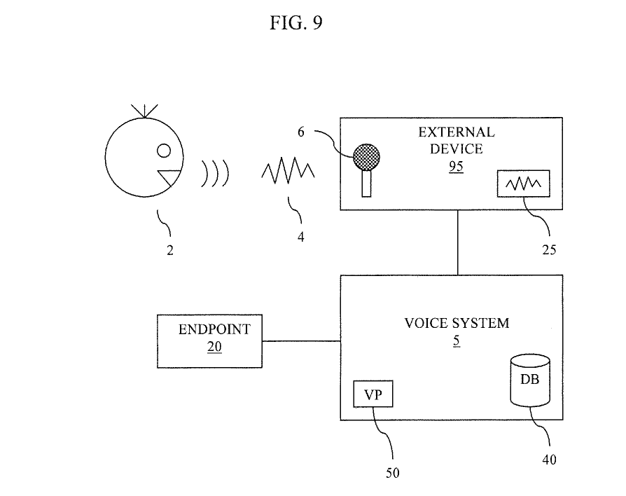

FIG. 9 illustrates an example block diagram of a voice system 5 connected to an external device 95. External device 95 may include a computer, terminal, personal digital assistant, mobile phone, or any other device capable of transmitting data, including voice data, to the voice system 5. The external device 95 is shown as including a recording device 6. The external device 95 may be configured to record a spoken name 4 or other voice signature of a customer 2 who is speaking into the recording device 6. The external device 95 may store the spoken name 4 as an audio recording including voice information 25. Voice information 25 may be transmitted from the external device 95 to the voice system 5. The voice information 25 may be stored in a database such as data storage device 40. The voice processing application 50 may control or manage the storage and retrieval of the voice information 25 at the request of the endpoint 20 or of the customer 2.

In one embodiment, the voice information 25 including the stored customer name or voice signature is further associated with contact information, including a customer e-mail address. The voice information 25 may be saved as a wave file or audio signal, for example. The voice information 25 may be stored with other customer information such as included in contact manager 70 of FIG. 4. In one embodiment, a user of the voice system 5 may play out the voice information 25 by clicking or otherwise selecting the wave file included in a contact information application.

In one embodiment, the voice information 25 is saved from an attachment or embedded object in an e-mail or web form. For example, customer 2 uses the external device 95 to send endpoint 20 an e-mail with their contact information including the voice information 25. The voice information 25 may include a previously recorded audio signal of the customer's name spoken in the customer's own voice. The voice information 25 may be included as part of an e-mail signature that is attached to, embedded in, or otherwise provided with the e-mail. For example, the e-mail signature may include one or more of a personal name, company name, phone number, fax number and voice signature. In another embodiment, the customer 2 may be prompted by a web form to speak their name while filling out customer information. Their spoken name may be recorded and stored in a field in a customer database.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. An apparatus comprising:
a voice processing application of a voice system configured to:
record a voice signature;
associate the voice signature with a customer identity;
store the voice signature; and
retrieve the voice signature using the customer identity, where the voice signature is recorded using the customer's own voice.

2. The apparatus according to claim 1 where the voice signature is recorded during a first voice call session, and the voice signature is retrieved during a second voice call session.

3. The apparatus according to claim 2 where the voice signature is retrieved prior to or during a call processing of the second voice call session, and where the voice processing application is further configured to cause the voice signature to be played out.

4. The apparatus according to claim 1 where the customer identity includes a telephone number.

5. The apparatus according to claim 4 where the voice processing application is further configured to change the stored voice signature or the telephone number at a request of the customer.

6. The apparatus according to claim 1 where the voice processing application is configured to retrieve the stored voice signature for multiple call sessions occurring at different times.

7. A method comprising:
capturing voice information including a customer's name spoken in the customer's own voice;
associating the voice information with a customer identification;
storing the voice information;
receiving a call indicating the customer identification; and
retrieving the voice information associated with the customer identification.

8. The method according to claim 7 including:
playing out the stored voice information prior to or during a call processing session.

9. The method according to claim 8 where the customer identification identifies a caller initiating the call session.

10. The method according to claim 7 including
playing out the stored voice information; and
processing the call by or to a customer.

11. The method according to claim 10 where the customer identification identifies the customer being called or who is calling.

12. The method according to claim 7 including replacing the stored voice data associated with the customer identification at a request of the customer.

13. The method according to claim 7 where the customer identification includes a direct inward dial (DID) phone number.

14. The method according to claim 7 where the stored voice data includes a name of the customer.

15. A system comprising:
a data storage device for storing an audio recording of a customer name recorded in the customer's own voice; and
a voice processing application for providing audio communication between the customer and a user of the system during a communication session, where the stored customer name is retrieved from the data storage device according to an associated customer identification and played out to the user of the system as part of the communication session.

16. The system according to claim 15 where the stored customer name is retrievable at multiple different times and by multiple different users of the system.

17. The system according to claim 15 where the stored customer name is played out during a call screening process prior to transferring the call to the user.

18. The system according to claim 5 where the stored customer name is played out after the user selects the customer identification from an automated attendant.

19. The system according to claim 15 where the stored customer name is further associated with contact information, including a customer e-mail address.

20. The system according to claim 19 where the stored customer name is saved from an attachment or embedded object in an e-mail or web form.
